(19) United States
(12) Patent Application Publication
(10) Pub. No.: US 2026/0145275 A1
(43) Pub. Date: May 28, 2026

(54) METHOD AND MACHINE FOR A LASER PROCESSING

(71) Applicant: ADIGE S.P.A., LEVICO TERME (IT)

(72) Inventors: Matteo Pacher, Levico Terme (TN) (IT); Davide Dolfi, &Levico Terme (TN) (IT); Mara Tanelli, Milano (IT); Barbara Previtali, Milano (IT); Sergio Savaresi, Milano (IT); Valentina Finazzi, Milano (IT); Giulio Delama, Milano (IT)

(21) Appl. No.: 19/123,413

(22) PCT Filed: Oct. 24, 2023
(86) PCT No.: PCT/IB2023/060717

§ 371 Date: Apr. 23, 2025

(30) Foreign Application Priority Data
Oct. 25, 2022 (IT) 102022000022032

(51) Int. Cl. B23K 26/38

(52) U.S. Cl. CPC B23K 26/38

(57) ABSTRACT

A laser processing method comprises directing a laser beam onto a work piece, executing a relative movement between the laser beam and the work piece, monitoring the laser processing process, determining at least one first quality parameter and verifying whether the at least one first quality parameter corresponds to a respective desired first quality parameter. Process parameters may then be modified in response to a determination that the first quality parameter does not correspond to the desired first quality parameter. Further steps include estimating whether a second quality parameter corresponds to a desired second quality parameter after the modification of the process parameters during the preceding steps and varying the process parameters when the second quality parameter does not correspond to the desired second quality parameter until the second quality parameter corresponds to the desired second quality parameter.

### CROSS-REFERENCE TO RELATED APPLICATIONS

This Patent Application claims priority from Italian Patent Application No. 102022000022032 filed on Oct. 25, 2022, the entire disclosure of which is incorporated herein by reference.

### TECHNICAL FIELD

The present invention relates to a laser processing method, preferentially for cutting and/or piercing and/or welding a work piece and/or executing an additive manufacturing for obtaining a work piece. Preferentially, the present invention relates to a laser processing method with a continuous closed-loop control of the laser processing quality, preferentially of the cutting or of the piercing of the work piece. Still more preferentially, the present invention relates to a laser processing method with a closed-loop control having a main loop and an auxiliary loop.

The present invention also relates to a laser processing machine configured to execute a laser processing method. Preferentially, the present invention relates to a laser processing machine configured to execute a laser processing method with a closed-loop control, preferentially having a main loop and an auxiliary loop, of the laser processing quality and preferentially with a closed-loop control of the processing so as to guarantee a predetermined processing quality.

### BACKGROUND

Laser processing machines are known, for example, for cutting and/or piercing work pieces. A typical laser processing machine comprises an emission source of a laser beam, a support for the work piece, an optical assembly for controlling the focus position of the laser beam, a generating device configured to create a gas jet for directing compounds created during the processing of the work piece away from the work piece and a movement device for executing a relative movement between the laser beam and the work piece.

In use, the qualitative result of cutting or piercing the work piece depends, for example, on the intensity of the laser beam, on the pressure of the gas jet and/or on the velocity of the relative movement between the laser beam and the work piece.

For example, when cutting in nitrogen, the formation of a burr at the lower edge of the cut or pierced portion of the work piece is known.

In theory, it is conceivable to set the process parameters in a pre-fixed manner so as to obtain the maximum obtainable quality, i.e. for example the absence of the burr. However, in order to obtain such result, it is necessary to set the values of the process parameters in an extremely conservative manner, thus causing a reduction in the productivity.

In order to optimize the compromise between quality and productivity, it is necessary to obtain, for example by means of simulations or practical estimates or by means of direct measurements, information about how to optimize the process parameters SO as to maximize the processing productivity simultaneously guaranteeing the quality thereof. It should be noted that the optimization of the process parameters results in the determination of a set of optimized process parameters which, however, are static, i.e. are not varied during the processing of the work piece. This means that in some circumstances, such set of optimized process parameters results in a non-optimal processing both in terms of productivity and quality.

In patent application EP-A-3838471, the Applicant proposed a method which allows obtaining a desired quality and simultaneously an optimization of the productivity.

The method proposed in the aforementioned patent application allows obtaining very satisfactory results.

However, the need is felt in the sector for a further improvement in the laser processing methods and/or in the laser processing machines, preferentially for cutting and/or piercing and/or welding work pieces and/or for executing an additive manufacturing of work pieces, with the possibility of preferentially continuously monitoring and adjusting the processing quality, and in particular for being able to easily managing laser processing in different environments/atmospheres.

### SUMMARY

The object of the present invention is to provide a laser processing method and a laser processing machine which allow improving the knowns methods, in particular so as to be able to easily manage laser processing in different environments/atmospheres.

In particular, the object of the present invention is to provide a laser processing method and a laser processing machine which allow a quality control and controlling the process parameters of the machine as a function of the quality obtained.

The aforementioned objects are achieved by the present invention, as it relates to a laser processing method as defined in the independent claim 1. Alternative preferred embodiments are protected in the respective dependent claims.

The aforementioned objects are also achieved by the present invention, as it relates to a laser processing machine according to claim 15.

### BRIEF DESCRIPTION OF THE FIGURES

In order to better understand the present invention, a preferred embodiment thereof is described in the following, by way of mere non-limiting example and with reference to the accompanying drawings, wherein:

FIG. 1 schematically and partially illustrates a laser processing machine according to the present invention;

FIG. 2a illustrates an example of an acquired image obtained during a laser processing by means of the operation of the processing machine of FIG. 1;

FIG. 2b illustrates a step of analyzing the acquired image of FIG. 2a;

FIG. 3 illustrates a time course of a characteristic parameter obtained from the analysis of a plurality of acquired images

FIG. 4 illustrates distributions of the characteristic parameter obtained from respective time courses of the characteristic parameter during the laser processing by means of the operation of the processing machine of FIG. 1 in two different conditions;

FIG. 5 schematically illustrates a control of the laser processing method; and

FIG. 6 schematically illustrates an example of a control of a laser processing.

### DESCRIPTION OF EMBODIMENTS

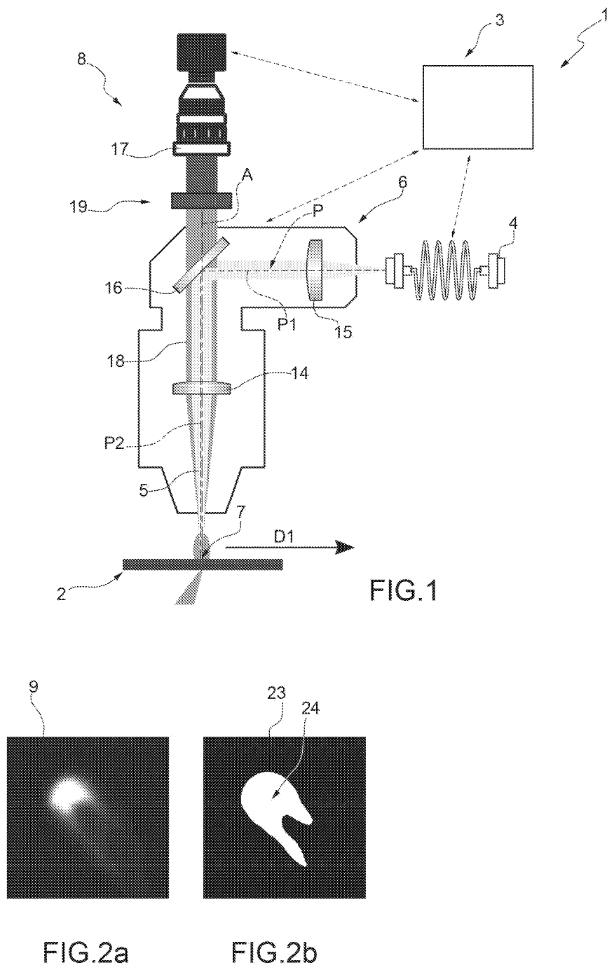

In FIG. 1, reference numeral 1 generically indicates, as a whole, a laser processing machine configured to execute a laser processing on a work piece, preferentially for cutting and/or piercing a work piece 2.

Preferentially, the work piece 2 can be of a metallic material. In particular, the work piece 2 can have a planar and/or tubular and/or bar shape.

In greater detail, the laser processing machine 1 comprises:
a control unit 3 for controlling the operation of the laser processing machine 1;
an emission source 4 of a laser beam 5 operatively connected to the control unit 3 and configured to emit the laser beam 5;
an optical assembly 6, preferentially operatively connected to the control unit 3, for controlling the laser beam 5, preferentially for directing the laser beam 5 along an optical axis A onto the work piece 2 and at a working zone 7;
a movement device, preferentially operatively connected to the control unit 3 and configured to execute a relative movement between the laser beam 5 and the work piece 2, preferentially at a determined velocity and/or preferentially to define the shape of the cutting and/or piercing.

### Preferentially, the Laser Processing Machine 1 Can Also comprise:

a generating device (not illustrated and known per se) operatively connected to the control unit 3 and configured to create a gas jet for directing compounds created during the laser processing, preferentially during the cutting and/or piercing of the work piece 2, away from the work piece 2.

According to some preferred non-limiting embodiments, the processing machine can also comprise a suction unit configured to remove fumes and/or by-products of the laser processing.

According to some preferred non-limiting embodiments, the control unit 3 can be configured to control process parameters of the laser processing machine 1, preferentially an intensity of the laser beam 5 and/or a frequency and/or a duty cycle of the pulsed regime of the laser beam 5 and/or a focus position of the laser beam 5 and/or a diameter of the laser beam 5 and/or a determined velocity of the relative movement between the laser beam 5 and the work piece 2 and/or the gas jet and/or a gas pressure of the gas jet and/or a position of a nozzle configured to emit a gas jet.

Preferentially, the control unit 3 can be configured to control the process parameters in feedback mode.

It should be noted that the process parameters are (substantially) all the parameters that define the operation of the laser processing machine 1.

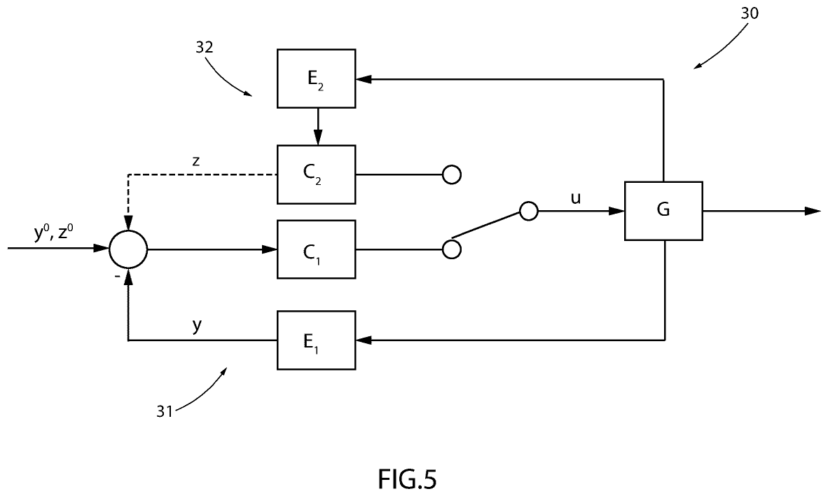

Advantageously and with particular reference to FIG. 5, the control unit 3 can comprise at least one closed control loop 30, preferentially each having a main loop 31 and an auxiliary loop 32.

Preferentially, each main loop 31 and the respective auxiliary loop 32 are engaged and hierarchical with respect to one another.

As is explained in greater detail in the following, the main loop 31 can be configured to control the control parameters in certain conditions and the auxiliary loop 32 can be configured to control the control parameters in other conditions which, however, are a direct consequence of the control executed by the main loop 31.

Preferentially, the laser processing machine 1 also comprises a monitoring device 8 configured to monitor the process and/or the result of the laser processing. Preferentially, the monitoring device 8 can be configured to monitor the cutting and/or piercing and/or welding and/or the additive process of the work piece 2.

Preferentially, the monitoring device 8 can be configured to acquire signals, preferentially optical signals, more preferentially a plurality of acquired images 9 (an exemplifying acquired image is illustrated in FIG. 2a), preferentially of the working zone 7.

In particular, the monitoring device 8 can be operatively connected to the control unit 3, which can be configured to control the operation of the laser processing machine 1 at least as a function of information extracted and/or obtained from the monitoring device 8, preferentially starting from the acquired signals, more preferentially from the acquired optical signals, still more preferentially starting from the acquired images 9. Preferentially, each closed control loop 30 can be configured to control the operation of the laser processing machine 1 at least as a function of information extracted and/or obtained from the monitoring device 8, preferentially starting from the acquired signals, more preferentially from the acquired optical signals, still more preferentially starting from the acquired images 9.

Preferentially, the monitoring device 8 can be configured to acquire the signals, preferentially the optical signals, more preferentially the acquired images 9, during the operation of the laser processing machine 1 (in other words, the monitoring device 8 can be configured to operate in an online mode).

According to some preferred non-limiting embodiments, the monitoring device 8 can be configured to acquire the process emission, i.e. the thermal emission of heat, preferentially present at the working zone 7. Alternatively, the monitoring device 8 can be configured to acquire an electromagnetic radiation (light) resulting from a lighting by means of a separate lighting source.

Preferentially, the emission source 4 can comprise a laser, for example an ND: YAG laser, a laser of the fiber type, a carbon dioxide laser or a diode laser.

In greater detail, the optical assembly 6 can be configured to direct the laser beam 5 onto the work piece 2 and determine the focus of the laser beam 5.

Preferentially, the optical assembly 6 can be configured to define an optical path P from the emission source 4 towards the work piece 2.

According to some non-limiting embodiments, the optical path P can comprise a first portion P1 transverse, more specifically perpendicular, to the optical axis A and/or a second portion P2 coaxial to the optical axis A.

In other words, the laser beam 5 propagates along the portion Pl and the portion P2 respectively, in which P1 is perpendicular to P2, in which preferentially the direction P2 coincides with the optical axis A.

Alternatively, the path p could be coaxial to the optical axis A.

According to some preferred embodiments, the optical assembly 6 can comprise at least one focusing lens 14 configured to determine the focus of the laser beam 5; preferentially the focusing lens 14 can be arranged in the portion P2.

Preferentially, the optical assembly 6 can also comprise a collimation lens 15 and a dichroic mirror 16 configured to deflect the laser beam 5 from the portion P1 to the portion P2. In particular, the collimation lens 15 can be arranged in the portion P1.

Alternatively, the dichroic mirror 16 can be configured to deflect the optical axis A and leave the path P of the laser beam 5 unaltered.

In greater detail, the movement device can be configured to control a movement of the laser beam 5 relative to the work piece 2 in a first relative advancement direction D1 and/or a second relative advancement direction transverse, preferentially perpendicular, to the first relative advancement direction D1.

According to some preferred embodiments, the movement device can comprise a support (not illustrated and known per se) configured to support the work piece 2, preferentially the support can be movable so as to be set in motion for obtaining the relative movement between the laser beam 5 and the work piece 2.

Alternatively or additionally, at least one portion of the movement device can be integrated in and/or associated with the support for moving the work piece 2 so as to obtain a relative movement between the laser beam 5 and the work piece 2.

Alternatively or additionally, the movement device can comprise a movable supporting base carrying the emission source 4 and/or the optical assembly 6 and/or a portion of the optical assembly 6 for moving the laser beam 5.

In greater detail, the monitoring device 8 can comprise at least one sensor, preferentially an optical sensor, configured to acquire the signals, preferentially the optical signals.

Preferentially, the sensor can be and/or comprises a video camera 17, for example of the CCD or CMOS type, configured to acquire the acquired signals, preferentially the acquired optical signals, more preferentially the acquired images 9.

More specifically, the video camera 17 can be configured to continuously acquire the acquired images 9, so as to obtain a temporal sequence of the acquired images 9.

Preferentially, the optical sensor, preferentially the video camera 17, can be configured to acquire an electromagnetic radiation beam 18 originating from the working zone 7.

According to some preferred non-limiting embodiments, the electromagnetic radiation beam 18 can correspond to the process emissions at the working zone 7. Alternatively, the electromagnetic radiation beam 18 can result from a lighting of the working zone 7, for example by means of a separate lighting source.

Preferentially, the electromagnetic radiation beam 18 can pass through at least one portion of the optical assembly 6, in particular the focusing lens 14 and the dichroic mirror 16.

According to some non-limiting embodiments, the optical sensor, preferentially the video camera 17, can be arranged coaxial to the optical axis A. More preferentially, the electromagnetic radiation beam 18 can propagate, in use, parallel to the portion P2.

Alternatively, the electromagnetic radiation beam 18 could propagate along a path having at least two portions transverse to one another.

In greater detail, the monitoring device 8 can also comprise an optical filtering assembly 19 configured to guarantee that the optical sensor, preferentially the video camera 17, receives, in use, light in a band of defined wavelengths. Preferentially, the optical filtering assembly 19 can operate in the near infrared (being a near-infrared filter).

In particular, the optical filtering assembly 19 can be arranged upstream of the video camera 17 relative to the third direction.

As is described in greater detail in the following, the control unit 3 can be configured to control the operation of the laser processing machine 1 so as to obtain a desired laser processing quality and guarantee a continuous operation of the laser processing.

In use, the laser processing machine 1 executes a laser processing, preferentially the laser processing machine 1 cuts and/or pierces the work piece 2.

Advantageously, the laser processing method, preferentially executed by the laser processing machine 1, comprises at least the following steps:
a) directing the laser beam 5 onto the work piece 2, preferentially at the working zone 7 of the work piece 2 and/or for executing the cutting and/or piercing of the work piece 2;
b) executing the relative movement between the laser beam 5 and the work piece 2, preferentially at a determined velocity, and preferentially for defining the shape of the cutting and/or piercing; and
c) monitoring the laser processing process and/or the result of the laser processing for obtaining information about the laser processing process and/or the result of the laser processing.

Furthermore, the method can comprise a method control, preferentially executed by the control unit, preferentially by at least one closed control loop 30, depending on the information obtained during the step c).

Advantageously, the method also comprises the steps of:
d) determining at least one first quality parameter y associated with at least one first effect of the laser processing from the information obtained during the step c); and
e) verifying whether the at least one first quality parameter y corresponds to a respective desired first quality parameter y⁰; and
f) modifying one or more process parameters so as to obtain at least one first quality parameter y corresponding to the respective desired first quality parameter y⁰, in response to the determination during the step e) that the at least one first quality parameter y does not correspond to the respective desired first quality parameter y⁰.

Preferentially, the steps from d) to f) are executed by the respective main loop 31 (see FIG. 5).

Furthermore, in response to the determination during the step e) that the first quality parameter y corresponds to the respective desired first quality parameter y⁰, the method repeats the steps from a) to e). More specifically, the steps from a) to e) are continuously executed and the step f) is executed the moment when the first quality parameter y does not correspond to the respective desired first quality parameter y⁰.

However, the Applicant observed that it can occur that the modification of the one or more process parameters during the step f) can result in the situation that at least one second quality parameter z associated with at least one second effect of the laser processing distinct from the first effect of the laser processing can no longer be satisfactory as a consequence of the modification of the process parameters. For this reason, the Applicant holds necessary to determine, preferentially in a predictive manner, whether or not the second quality parameter z continues to correspond to a desired second quality parameter z⁰. In the case where the second quality parameter z is no longer acceptable, it becomes necessary for the method control, preferentially by means of the control unit 3, more preferentially by means of a respective closed control loop 30, still more preferentially by means of the respective auxiliary loop 32, to be led by the need to guarantee that the second quality parameter z remains in an acceptable range around the desired value z⁰.

According to some preferred non-limiting embodiments, the desired first quality parameter y⁰ can vary and/or be updated during the execution of the method. Alternatively or additionally, the desired second quality parameter z⁰ can vary and/or be updated during the execution of the method.

Advantageously, the method also comprises the steps of:
g) estimating after the step f), preferentially in a predictive manner, whether at least one second quality parameter z associated with at least one second effect of the laser processing different from the at least one first effect corresponds to at least one desired second quality parameter z′ after the modification of the one or more process parameters during the step f) ; and
h) varying the one more process parameters in response to the estimate during the step g) that the at least one second quality parameter z does not correspond to the respective desired second quality parameter z⁰ and for obtaining that the at least one second quality parameter z corresponds to the respective desired second quality parameter z⁰.

Furthermore, the one or more process parameters are not modified in response to the estimate during the step g) that the at least one second quality parameter z corresponds to the respective desired second quality parameter z⁰.

More specifically, the step h) is executed the moment when it is estimated that the second quality parameter z does not correspond to the respective desired second quality parameter z⁰.

By having a method with the steps g) and h), it is possible to prevent the laser processing from being executed with process parameters that lead the second quality parameter z to a non-acceptable condition.

Preferentially, the steps g) and h) are executed by the respective auxiliary loop 32.

According to some embodiments, the auxiliary loop 32 operates depending on the second quality parameter z, but not depending on the first quality parameter y.

It should be noted that during the step h) the one or more process parameters can be varied directly and/or indirectly. For example, a direct variation can be executed by the auxiliary loop 32 directly interacting on the process parameters and/or an indirect variation can be executed by the auxiliary loop 32 by means of a modification of the desired first quality parameter y⁰.

According to some preferred non-limiting embodiments, the value of the first quality parameter y, the value of the second quality parameter z, the value of the desired first quality parameter y⁰ and the value of the desired second quality parameter z⁰ can vary in time.

According to some embodiments, preferentially if during the step h) the one or more process parameters can be varied only indirectly or directly and indirectly, the step h) can be executed in collaboration between the control by the respective auxiliary loop 32 and the respective main loop 31.

Preferentially, the step g) is executed in a predictive manner. In this manner, it is guaranteed that the step h) is promptly executed and before the second quality parameter z no longer corresponds to the respective desired second quality parameter z⁰.

Preferentially and with particular reference to FIG. 5, the main loop 31 can control the process parameters in response to the estimate during the step g) that the at least one second quality parameter z corresponds to the respective desired second quality parameter z⁰ and for obtaining a first quality parameter y corresponding to the desired first quality parameter y⁰. In other words, it is the main loop 31 that controls the method.

According to some embodiments, the main loop 31 can control the process parameters depending on the first quality parameter y, but not depending on the second quality parameter z.

Furthermore, the auxiliary loop 32 can control, for example directly and/or indirectly, the process parameters in response to the estimate during the step g) that the at least one second quality parameter z does not correspond to the respective desired second quality parameter z⁰ and for obtaining that the at least one second quality parameter z corresponds to the respective desired second quality parameter z⁰. In other words, in this condition it is the auxiliary loop 32 that controls the method. According to some embodiments, this control by means of the auxiliary loop 32 can also occur by means of a modification of the desired first quality parameter y⁰ and an interaction with the main loop 31. According to such embodiment, the auxiliary loop 32 interacts with the main loop 31 and controls the process parameters in this manner.

It should be noted that according to such a control strategy, it is considered that a degradation of the second quality parameter z to a non-desired situation is to be prevented and, consequently, a priority to the control of the second quality parameter z is assigned.

It should be noted that the method is executed in real time and/or for each work piece 2.

According to some embodiments, the steps from c) to h) are executed during the execution of the steps a) and b).

According to some non-limiting embodiments, the steps a) and b) are executed for cutting and/or piercing the work piece 2, preferentially at the working zone 7. Furthermore, according to such embodiment, during the step c) the cutting and/or piercing process, preferentially the result of the cutting and/or the piercing is monitored.

Preferentially and as is illustrated in FIG. 5, during the step h), a variation of the one or more process parameters is executed depending on the at least second quality parameter z.

Preferentially, during the step h) the desired first quality parameter y⁰ is modified and/or updated, in particular for preventing the occurrence of an undesired second quality parameter z. In particular, during the step h) the desired first quality parameter y⁰ is modified to a value which corresponds to a different quality in comparison to the previous desired first quality parameter y⁰. In this manner it is possible to guarantee that the second quality parameter z does not degrade. In other words, when it is estimated that the second quality parameter z degrades to an undesired value, the requirement relative to the first quality parameter y and/or to the first effect is modified; still in other words, this constraint relative to the first quality parameter y and/or to the first effect is “relaxed” (i.e. a desired first quality parameter y⁰ greater than the ideal case is tolerated), so that the process parameters can move in the direction of preventing an undesired second quality parameter z, which in particular is a situation to be prevented.

It should be noted that according to such embodiments it is possible to indirectly control the one or more process parameters by means of the modification of the desired first quality parameter y⁰ which results, preferentially from the operation of the respective main loop 31, in a modification of the one or more process parameters. Preferentially, the auxiliary loop 32 controls the main loop 31 by means of the modification of the desired first quality parameter y⁰.

It should be noted that each one between the first effect and the second effect corresponds to a respective result of the laser processing such as for example a roughness or the burr formation as first effects or a loss of cut or the rising of a deteriorated part of a lateral surface of a cutting slot as second effect.

In greater detail, in FIG. 5 the laser processing is indicated by G, E1 describes the first effect, C1 the control of the first quality parameter y, E2 describes the second effect, C2 the control of the second quality parameter z and u represents the control parameter or the control parameters.

For example, it is possible that a work piece 2 made of metal, such as for example carbon steel, is cut and/or pierced. According to such example, it is possible that a first effect is the presence of a roughness of the cut and/or pierced portions and the desired first quality parameter y⁰ can correspond to a desired roughness (i.e. an average roughness value), preferentially a roughness (i.e. an average roughness value) which is in a determined range. In the case where during the step e) it is determined that it is necessary to execute the step f), it is necessary to verify, preferentially in a predictive manner, that the modifications of the process parameters cannot lead to a loss of cut which defines the second effect. In the specific case, a second quality parameter is defined which is bound to the second effect of the loss of cut. In the specific example it can be noted that the second effect is an effect that is to be prevented because in the case of its manifestation it will be necessary to reprocess the work piece 2 resulting in production delays and material waste. Therefore, if subsequently, during the step g) it is estimated that the modified process parameters may lead to a loss of cut (i.e. that the second quality parameter z is no longer acceptable) the step h) is executed to guarantee that the second quality parameter z remains acceptable. Preferentially, during the step h) the desired first quality parameter y⁰ is modified, i.e. in the specific case the desired roughness (i.e. a desired average roughness value), so as to prevent the occurrence of the loss of cut. In particular, if an incipient loss of cut is estimated, the requirement of performance on roughness is degraded, therefore this constraint is “relaxed” (i.e. a desired roughness (i. e. a desired average roughness value) greater than the ideal case is tolerated), so that the process parameters can move in the direction of preventing the loss of cut, which is an event to be prevented.

Another example concerns the case of the laser cutting and/or piercing of a work piece 2 of aluminum material. The first effect can be the burr formation and the second effect is the rising of a deteriorated part of a lateral surface of a cutting slot.

In greater detail, the control unit 3, for example by means of one or more closed control loops 30, controls the laser processing machine 1 for executing the laser processing method, preferentially for processing the work piece 2.

Preferentially, the control unit 3 controls the laser processing machine 1 for executing at least the steps from a) to b).

According to some embodiments, the steps a) and b) are continuously executed on the work piece 2, and preferentially according to a defined scheme and for obtaining a desired result.

According to some embodiments, the steps from c) to h) are executed during the execution of the steps a) and b).

Preferentially, the method can also comprise one or more steps i) of repeating, during which the steps from c) to h) are repeated. Still more preferentially, the step or the steps i) are executed during the execution of the steps a) and b).

In this manner, it is guaranteed that the laser processing is continuously controlled.

According to a preferred embodiment, the first effect can be a continuous effect and the respective first quality parameter y is continuously variable.

In particular, this means that a modification of one or more process parameters, as it occurs for example during the step e), can result in a continuous modification of the result of the processing relative to the first effect. In other words, a modification of one or more process parameters can result in a continuous variation of the quality parameter y which can or cannot be acceptable (i.e. which corresponds or does not correspond to the desired quality parameter y⁰). Preferentially, the desired quality parameter y⁰ can define a range of acceptable quality parameters y.

Examples of first effects can be a surface roughness or the burr formation resulting from the laser processing, preferentially from the cutting and/or piercing. These effects can be described by means of respective quality parameters y which vary according to a continuous law with the modification of one or more process parameters.

The second effect can be a discrete effect and the respective second quality parameter z varies discretely between an acceptable quality and a non-acceptable quality.

More specifically, the second effect can be an effect for which the modification of one or more process parameters, as it can for example occur during the step f), does not result in a modification of the result of the laser processing relative to the second effect (which consequently remains acceptable) or results in a modification of the result of the processing that becomes non-acceptable. In other words, the modification of one or more process parameters does not result in a modification of the respective second quality parameter z or results in a modification of the respective second quality parameter z which is non-acceptable.

Examples of discrete second effects are a loss of cut, a deterioration of a portion of the work piece 2 or a plasma formation. It is clear that these effects are or are not present and, furthermore, these effects are to be prevented.

In other words, the second quality parameter z can be defined to vary between an acceptable value (for example defined as z=0) and a non-acceptable value (for example defined as z=1). An increase in the second quality parameter z means, in the specific example, a worsening of the respective quality which is a situation to be prevented

Therefore, according to such preferred embodiments, the method provides for the quality control to concern continuous effects and, if, in order to guarantee a desired quality relative to such a continuous effect, a modification of the process parameters is necessary, it is controlled that this modification does not result in the occurrence of an undesired and discrete effect.

According to some embodiments, during the steps d) and e) a plurality of first quality parameters y (i.e. a set of first quality parameters y) can be determined and verified respectively, preferentially each associated with a respective first effect (distinct from the other first effects), preferentially with a first continuous effect. Preferentially, during the step f) one or more process parameters can be modified depending on one or more quality parameters y, in particular for guaranteeing that the quality parameters y correspond to the respective desired quality parameters y⁰.

Additionally or alternatively, during the step g) a plurality of second quality parameters z (i.e. a set of second quality parameters z) can be estimated, preferentially each associated with a respective second effect (distinct from the other second effects), preferentially with a respective discrete second effect. Preferentially, during the step h) one or more process parameters can be modified depending on one or more second quality parameters z, in particular for guaranteeing that the second quality parameters z correspond to respective desired second quality parameters z⁰.

According to some preferred embodiments, the method can further comprise a step j) of defining, during which one or more pairs of at least one respective first effect and of a respective second effect are defined.

For example, a pair can be defined by the roughness as first effect and by the loss of cut as second effect.

Another example is a pair defined by the burr formation as first effect and by the deterioration of a portion of the work piece 2 and/or of a slot.

According to some non-limiting embodiments, one or more pairs can be defined by more than a first effect and/or more than a second effect.

According to some non-limiting embodiments, each pair can be associated with a respective closed control loop 30 having a respective main loop 31 and a respective auxiliary loop 32.

Preferentially, each first effect and the respective second effect, for example of a respective pair, can be competing effects. This means that an improvement of the respective first quality parameter y as a consequence of a modification of one or more process parameters can provoke a deterioration of the respective second quality parameter z. For example, in the case that the first effect is a roughness and the second effect is a loss of cut it can occur that during the step e) it is determined that the roughness (i.e. the respective first quality parameter y; i.e. the respective average value) cannot correspond to the desired roughness (i.e. the respective first quality parameter y; i.e. the respective average value) and during the step f) one or more process parameters are updated such as the determined velocity which for example can be increased. However, an increase in the determined velocity can result in the loss of cut.

Furthermore, the fact that the first effect and the second effect can be competing effects also means that an improvement of the second quality parameter Z as a consequence of a modification of one or more process parameters provokes a deterioration of the first quality parameter y. Returning to our example, in order to prevent a loss of cut it can be necessary to decrease the determined velocity which, in turn, leads to a greater roughness.

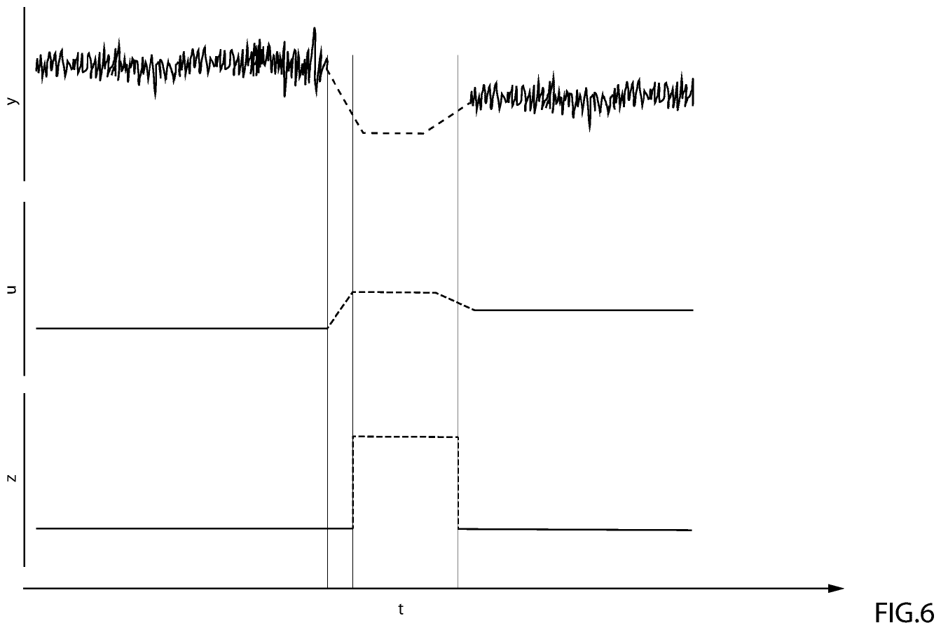

FIG. 6 schematically illustrates the control of the laser processing according to the present invention with reference to the example that the first effect is the roughness (represented by y), the second effect is the loss of cut (represented by z) and the process parameter which is varied is the velocity (represented by u) (of the relative movement between the work piece 2 and the laser beam 5).

In the example of FIG. 6 it can be noted that at the beginning the velocity is constant and there is a roughness which varies around a first average value, the loss of cut is not present and the velocity is constant. However, according to the example, the respective first quality parameter y does not correspond to the desired first quality parameter y⁰ (i.e. the desired roughness) and, consequently, the control unit 3, preferentially the respective control loop 30, more preferentially the respective main loop 31, controls an increase in the velocity which would result in a reduction of the average roughness value as is schematically indicated by the respective dashed lines. However, if the velocity were maintained increased, also the loss of cut would occur (see the respective dashed parts). Therefore, the control unit 3, preferentially the respective control loop 30, more preferentially the respective auxiliary loop 32, has to counter the possible loss of cut, preferentially before such loss of cut is manifested. Consequently, the velocity is lowered to a value that leads to an average roughness value greater than that originally desired, but which guarantees the non-occurrence of the loss of cut. For example, the auxiliary loop 32 con control an updated desired first quality parameter y⁰. This updated desired first quality parameter y⁰ is then considered by the main loop 31 for setting a new velocity at which the loss of cut is not present.

According to some preferred embodiments, the steps from c) to h) are executed in consideration of each pair, and preferentially in consideration of the respective first effect and of the respective second effect.

In the case that a plurality of pairs are defined, the steps from c) to h) are executed, preferentially simultaneously or alternatively, relatively for each pair.

According to some embodiments, the first effect or the first effects and the second effect or the second effects and/or the pair or pairs which are to be considered during the steps e), f), g) and h) depend on the material of the work piece 2.

In greater detail, during the step a), the emission source 4 can emit the laser beam 5 and the optical assembly 6 can direct the laser beam 5 onto the work piece 2. Preferentially, the control unit 3 can control by means of a control of the optical assembly 6, preferentially of the focusing lens, the focus of the laser beam 5.

Preferentially, during the step b), the work piece 2 and/or the laser beam 5 is moved. In particular, during the step b), the support which carries the work piece 2 and/or the supporting base which carries the emission source 4 and/or the optical assembly 6 is or are moved. More preferentially, only the support for moving only the work piece 2 is moved.

Preferentially, during the step b), also a relative movement can be executed between the monitoring device 8 and the work piece 2. More preferentially, no relative movement is executed between the laser beam 5 and the monitoring device 8. It should be noted that due to the relative movement between the laser beam 5 and the work piece 2 also the working zone 7 varies relative to the work piece 2 in time.

According to some embodiments, during the step e) and/or during the step g) the information obtained during the step c) can be analyzed.

In greater detail, during the step c), a sub-step of acquiring can be executed, during which signals, preferentially optical signals, more preferentially acquired images 9, of the working zone 7 are acquired, preferentially by means of the monitoring device 8, more preferentially by means of the video camera 17.

Furthermore, during the step d) the first quality parameter y is determined (or the first quality parameters y are determined), preferentially by the control unit 3, starting from the signals, preferentially from the optical signals, more preferentially starting from the acquired images 9.

Alternatively or additionally, during the step g) the second quality parameter z or the second quality parameters z are estimated, preferentially by the control unit 3, starting from the signals, preferentially from the optical signals, more preferentially starting from the acquired images 9.

Preferentially, during the step c), the signals, preferentially the optical signals, more preferentially the acquired images 9, result from the process emissions (i.e. from the heat).

Preferentially, during the step c) a time course of the signals, preferentially of the optical signals, more preferentially of the acquired images 9 is obtained.

In greater detail, the analysis of the signals, preferentially of the optical signals, more preferentially of the acquired images 9, is executed in a similar manner for determining or estimating, respectively, each first quality parameter y and each second quality parameter z. In other words, the steps d) and g) are similar and/or the respective analyses are similar.

Preferentially, the control unit 3 analyzes the signals, preferentially the optical signals, more preferentially the acquired images 9.

In the following, the analysis of the signals, preferentially of the optical signals, more preferentially of the acquired images 9, is described in general terms, making specific references to the steps d) and g) if held necessary.

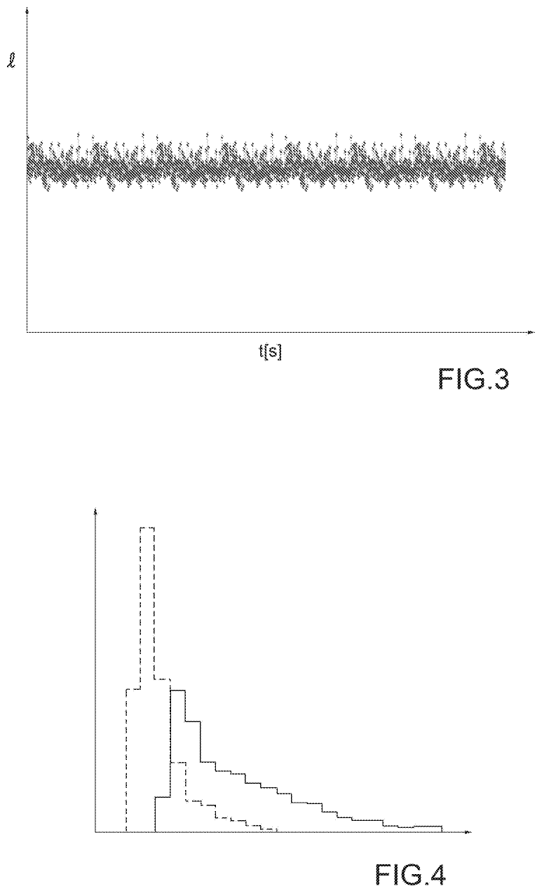

More specifically, the analysis of the signals, preferentially of the optical signals, more preferentially of the acquired images 9, provides for:
determining a time course of one or more characteristic parameters (see FIG. 3) from the signals, preferentially from the optical signals, more preferentially from the acquired images 9;
calculating one or more statistical parameters from the time course of the characteristic parameter; and
establishing or estimating the respective quality parameter on the basis of the statistical parameter or statistical parameters.

Preferentially, the time course of each characteristic parameter is determined for a defined time, preferentially defined and constant.

Preferentially and with particular reference to figures from 2a to 2b, the analysis of the signals, preferentially of the optical signals, more preferentially of the acquired images 9, provides for a transformation into transformed signals, preferentially transformed optical signals, more preferentially into transformed images 23. Then, each characteristic parameter is obtained from the transformed signals, preferentially from the transformed optical signals, more preferentially from the transformed images 23.

Preferentially and in greater detail, during the transformation of the signals, preferentially of the optical signals, more preferentially of each acquired image 9, it is possible to obtain a high-intensity zone 24.

Preferentially, the transformation can provide for a threshold analysis of the acquired images 9.

Preferentially, the analysis of the signals, preferentially of the optical signals, more preferentially of the acquired images 9, can comprise the determination of one or more characteristic parameters defined by or as a function of the high-intensity zones 24.

In greater detail, the statistical parameter or statistical parameters can be extracted, preferentially by the control unit 3, from a respective probabilistic distribution (see FIG. 4) of the time course of each characteristic parameter. For example, each statistical parameter is chosen from the group consisting of the respective average value, of the respective variance and of the respective asymmetry index of the respective probabilistic distribution.

In greater detail, the quality parameters can be obtained from the statistical parameter or from the statistical parameters by means of a non-linear function or a linear function, preferentially by means of a non-linear function.

Preferentially, the method can also provide for a step of defining the desired first quality parameter or the desired first quality parameters y⁰ and the desired second quality parameter or the desired second quality parameters z⁰.

According to some non-limiting embodiments, the method can also provide for a step of modifying, during the desired first quality parameter or the desired first quality parameters y⁰ and/or the desired second quality value or the desired second quality values z⁰ can be modified. For example, the step of modifying can be actuated by an operator and/or by the control unit 3 automatically.

Preferentially, the laser processing machine 1 can be actuated according to the described method.

By examining the characteristics of the laser processing machine 1 and of the method according to the present invention, the advantages which it allows obtaining are evident.

In particular, it is possible to control the laser processing quality.

A further advantage lies in the fact that it is possible to manage laser processing in different atmospheres such as, for example, in nitrogen and in oxygen.

Another advantage is that it is possible to manage different materials having different characteristics.

Furthermore, it is possible to obtain a reasonable compromise between a desired laser processing quality and the productivity.

Additionally, it is guaranteed that while continuous effects are optimized relative to the respective desired quality parameters, the occurrence of discrete effects is prevented.

Finally, it is clear that modifications and variations can be made to the laser processing machine 1 and to the method described and illustrated herein without departing from the scope of protection defined by the appended claims.

1. A laser processing method of a work piece preferentially of a metallic material, comprising at least the steps of:
a) directing a laser beam onto the work piece, preferentially for executing a cutting and/or piercing and/or welding and/or an additive manufacturing;
b) executing a relative movement between the laser beam and the work piece;
c) monitoring the laser processing process and/or the result of the laser processing for obtaining information about the laser processing process and/or the result of the laser processing;
d) determining at least one first quality parameter (y) associated with at least one first effect of the laser processing from the information obtained during the step c); and
e) verifying whether the at least one first quality parameter (y) corresponds to a respective desired first quality parameter (y⁰);
f) modifying one or more process parameters so as to obtain at least one first quality parameter (y) corresponding to the respective desired first quality parameter (y⁰) in response to the determination during the step e) that the at least one first quality parameter (y) does not correspond to the respective desired first quality parameter (y⁰);
g) estimating after the step f), preferentially in a predictive manner, a second quality parameter (z) associated with at least one second effect of the laser processing different from the at least one first effect and comparing the second quality parameter (z) with at least one desired second quality parameter (z⁰); and
h) varying the one or more process parameters in response to the estimate executed during the step g) for obtaining that the at least one second quality parameter (z) corresponds to the respective desired second quality parameter (z⁰).

2. Method according to claim 1, wherein during the step h) the desired first quality parameter (y⁰) is modified to a value which corresponds to a different quality in comparison to the previous desired first quality parameter (y⁰).

3. Method according to claim 1, wherein the steps from d) to h) are controlled in a closed control loop having a main loop and an auxiliary loop;
wherein the main loop controls the one or more process parameters in response to the estimate during the step g) that the at least one second quality parameter (z) corresponds to the respective desired second quality parameter (z⁰) and for obtaining a first quality parameter (y) corresponding to the desired first quality parameter (y⁰); and
the auxiliary loop controls the one or more process parameters, preferentially directly or indirectly, in response to the estimate during the step g) that the at least one second quality parameter (z) does not correspond to the respective desired second quality parameter (z⁰) and for obtaining that the at least one second quality parameter (z) corresponds to the respective desired second quality parameter (z⁰).

4. Method according to claim 3, wherein the auxiliary loop controls the one or more process parameters without considering the first quality parameter (y) in response to the estimate during the step g) that the at least one second quality parameter (z) does not correspond to the respective desired second quality parameter (z⁰) and for obtaining that the at least one second quality parameter (z) corresponds to the respective desired second quality parameter(z⁰).

5. Method according to claim 1, wherein the method further comprises a step i) of repeating the steps from c) to h); and/or
wherein during the step g) the information obtained during the step c) is analyzed.

6. Method according to claim 1, wherein the at least one first effect is a continuous effect and the at least one first quality parameter (y) is continuously variable and the at least one second effect is a discrete effect and the at least one second quality parameter (z) varies discretely between an acceptable quality and a non-acceptable quality.

7. Method according to claim 6, wherein for the at least one first effect a modification of one or more process parameters results in a continuous modification of the laser processing result; and for the at least one second effect a modification of one or more process parameters results in an acceptable laser processing result or a non-acceptable laser processing result.

8. Method according to claim 1, wherein the first effect and the second effect are competing effects in such a way that an improvement of the first quality parameter (y) as a consequence of a modification of one or more process parameters can provoke a deterioration of the second quality parameter (z) and an improvement of the second quality parameter (z) as a consequence of a modification of one or more process parameters provokes a deterioration of the first quality parameter (y).

9. Method according to claim 1, wherein the at least one first effect and the at least one second effect depend on the material of the work piece.

10. Method according to claim 1, wherein the at least one first effect is chosen from the group consisting of a surface roughness and a burr formation resulting from the laser processing; and/or
wherein the at least one second effect is chosen from the group consisting of a loss of cut, a deterioration of a portion of the work piece and a plasma formation.

11. Method according to claim 1, further comprising a step j) of defining at least one first pair of at least one respective first effect and at least one respective second effect.

12. Method according to claim 11, wherein during the step j) the at least first pair of a respective first effect and of a respective second effect and a second pair of a respective first effect and of a respective second effect are defined;
wherein the steps from c) to h) are executed, preferentially simultaneously or alternatively, relatively for each of the first pair and the second pair.

13. Method according to claim 1, wherein during the step c) a sub-step of acquiring signals, preferentially optical signals, from a working zone being under processing by the laser beam is executed;
wherein during the step d) at least one first quality parameter (y) is determined from the signals, preferentially the optical signals; and/or
wherein during the step g) at least one second quality parameter (z) is determined from the signals, preferentially the optical signals;
wherein during the sub-step of acquiring a plurality of images of the working zone are acquired as said signals.

14. Method according to claim 1, wherein the method is executed in real time and/or for each work piece and/or the steps from c) to h) are executed during the execution of the steps a) and b).

15. Laser processing machine comprising:
a control unit for controlling the operation of the laser processing machine
an emission source operatively connected to the control unit and configured to emit a laser beam;
an optical assembly for controlling the laser beam; and
a movement device operatively connected to the control unit and configured to execute a relative movement between the laser beam and the work piece;
wherein the control unit is configured and/or programmed to control the emission source and/or the optical assembly and/or the movement device in such a manner so as to execute a method according to claim 1.
